(19) United States
(12) Patent Application Publication
(10) Pub. No.: US 2005/0015389 A1
(43) Pub. Date: Jan. 20, 2005

(54) Intelligent metadata attribute resolution

(75) Inventors: Michael Novak, Redmond, WA (US); Daniel Plastina, Sammamish, WA (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Microsoft Corporation

(21) Appl. No.: 10/623,009

(22) Filed: Jul. 18, 2003

(51) Int. Cl. G06F 17/00

(52) U.S. Cl. 707/100

(57) ABSTRACT

A method and system for retrieving metadata for a media file. A source selection component includes instructions for querying a plurality of metadata sources in a predetermined order to retrieve metadata for the media file. The source selection component also includes instructions for retrieving metadata from metadata sources according business rules as required for specific metadata. A graphical user interface displays metadata from the first source identified as having available metadata, or displays metadata from the source designated by business rules.

### TECHNICAL FIELD

Embodiments of the present invention relate to the field of digital media. In particular, embodiments of this invention relate to metadata source selection for retrieving media content.

### BACKGROUND OF THE INVENTION

Due to recent advances in technology, computer users are now able to enjoy many features that provide an improved user experience, such as playing various media and multimedia content on their personal or laptop computers. For example, most computers today are able to play compact discs (CDs) so users can listen to their favorite musical artists while working on their computers. Many computers are also equipped with digital versatile disc (DVD) drives enabling users to watch movies.

In some multimedia environments, a computer has access to a computer-readable medium storing compressed media files such as Moving Picture Experts Group audio layer-3 (MP3) files and WINDOWS® MEDIA technologies audio (WMA) and video files. The computer typically organizes the media files into playlists when the compressed media files are played on the computer. The files may be organized according to metadata associated with the media content. Metadata for a digital media file such as an audio file includes general information pertaining to the media file itself. This information is typically stored within the file. For example, an audio file may have metadata tags for the song title, song artist, album title, and a rating. For example, in the case of audio media files, the files may be organized by album, artist, genre, date, or some user-specified selection and ordering. A user easily navigates through this organization using menus and graphical displays to render the desired media files.

However, some media files lack metadata or can have metadata assigned by a metadata source. The organization of such media files without relevant metadata is limited. There is a need for obtaining metadata for such media files. Moreover, as metadata can for a specific media file can be retrieved from a variety of sources, there is a need for automatically designating a sequence for querying each of such sources to retrieve metadata for such media files.

Some existing systems employ a last writer wins approach when retrieving metadata to display for a media file. That is, the last version of a particular metadata attribute that was written is the same version returned the next time the particular metadata attribute is requested for displaying metadata for the media file. However, such systems fail to enforce proper business rules, and fails to recognize a particular metadata sources may be unavailable in the future.

Accordingly, a system for automatically querying metadata sources according to a sequence and/or business rules to retrieve metadata, and to enable organization of the media content is desired to address one or more of these and other disadvantages.

### SUMMARY OF THE INVENTION

The invention meets the above needs and overcomes one or more deficiencies in the prior art by providing an improved user experience when retrieving metadata associated with various media files for display when the media files are being played on a media player. In particular the invention queries potential metadata sources according to a predetermined priority to retrieve and display metadata for the media file being played. The invention retrieves metadata specified by the source of the medial file prior to retrieving metadata specified in any other metadata source. The invention allows metadata sources to come and go by retrieving metadata from a preferred source when available, and by retrieving metadata from the next available source in the predetermined priority when a preferred source is unavailable. The invention can also override the source priority when business rules, associated with particular metadata, specify a particular metadata source from which to retrieve metadata. Moreover, by prioritizing metadata sources according retrieval time, sources that provide metadata in the least amount of time can be queried first. As a result, metadata is consistently retrieved from a preferred source, and retrieval time is reduced, and the over all experience of the user is enhanced.

In accordance with one aspect of the invention, a method is provided for retrieving a property of a media file being played via a media player, and wherein the media file is retrieved from one of a plurality of media file sources, which are prioritized. The method includes identifying a source of the media file. The method further includes retrieving the property as defined by metadata of the identified source of the media file.

In accordance with another aspect of the invention, a computer readable medium includes computer executable instructions for retrieving a property of a media file being played via a media player, wherein the media file is retrieved from one of a plurality of media file sources, which are prioritized. Identifying instructions identify a source of the media file. Retrieving instructions retrieve the property as defined by metadata of the identified source of the media file.

In accordance with another aspect of the invention, a computer readable medium stores a data structure. The data structure has a first data field that includes data representing a plurality of metadata sources, and each metadata source specifies metadata to retrieve while playing a media file via a media application. The data structure has a second data field that includes data representative of the media file. The data structure has a third functioning field identifying one of the plurality of metadata sources as a function of the data contained in the second data field. The metadata included in the identified metadata source is retrieved while playing the media file via the media application.

Alternatively, the invention may comprise various other methods and apparatuses.

Other features will be in part apparent and in part pointed out hereinafter.

### BRIEF DESCRIPTION OF THE DRAWINGS

FIG. 1 is an exemplary computer system in which the present invention can be used.

FIG. 2 is an exemplary block diagram illustrating the components of a media file.

FIG. 3 is an exemplary block diagram illustrating components of a media player application according to one embodiment of the invention.

FIG. 3A is an exemplary block diagram illustrating a querying priority for a plurality of metadata sources.

FIG. 4 is an exemplary flow chart illustrating a method of retrieving metadata of a media file according to one embodiment of the invention.

FIG. 5 is a block diagram illustrating one example of a suitable computing system environment in which the invention may be implemented.

Corresponding reference characters indicate corresponding parts throughout the drawings.

### DETAILED DESCRIPTION OF THE INVENTION

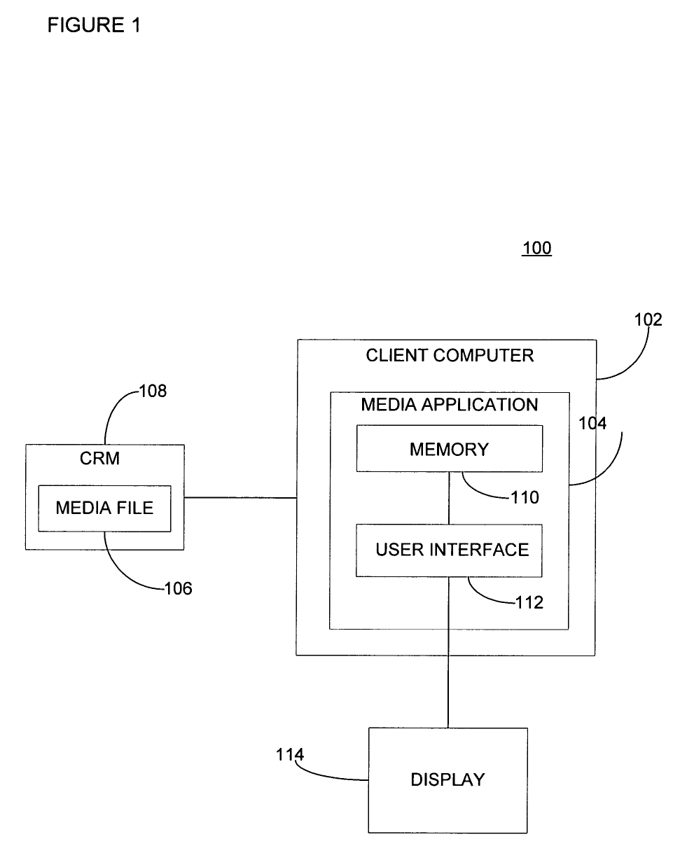

Referring now to the drawings, FIG. 1 illustrates an exemplary computer system 100 in which the present invention can be used. A system 100 includes a client computer 102 that executes a media player application 104. The media player application 104 can be any suitable rendering filter or program that is configured to play digital media so that a user can experience the content embodied on the media. For example, suitable media player applications 104 include a CD media player application and a DVD media player application. Executing the media player application 104, allows the user to access a digital media file 106 on a computer-readable medium (CRM) 108 such as a compact disc, a network server, or any other suitable computer storage media, and enables the user or, particularly, enables media player application 104 to access, retrieve, store, and display for the user, so-called metadata. Those skilled in the art are familiar with metadata, which is simply information about data or some entity. In the context of the present invention, metadata involves information related to specific content of a digital media file 106 being played via the media player application 104. Basic metadata may include one or more of album title, artist, performer, genre, description of content, and the like. Extended metadata includes cover art, performer biographies, reviews, related performers, where to buy similar items, upcoming concerts, ticket sales, URLs to other related experiences including purchase opportunities, and the like. The media player application 104 includes a memory 110 for storing digital media files 106, and a graphical user interface 112 for displaying media files 106 and metadata to the user on a display 114.

In the examples herein, the media content of digital media file 106 refers to a single song track or a collection of tracks such as found on an audio CD or in a playlist file. A playlist file (playlist) is a file that specifies a customized list of media files to play via a media player, and may include information (i.e., metadata) for one or more of the media files in the customized list. The media player application 104 reads the playlist to play the specified media files 106, and/or to display information associated with the media files 106. In particular, the playlist specifies location information for a list of media files 106 such that each media file in the list can be retrieved and played by the media player application 104. For example, the playlist can specify tracks from various CDs, media files from a hard disk, and/or media files from a remote server. When the user plays an item from a playlist, the media player application 104 accesses each specified media file 106 from its location and plays the media file 106.

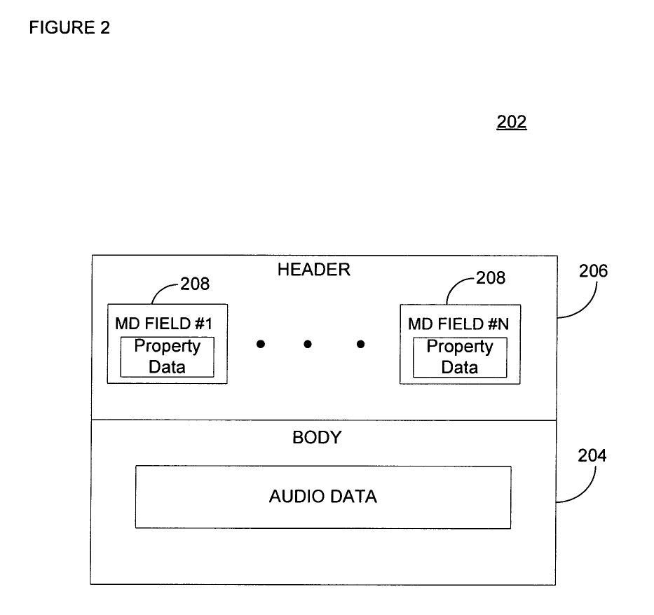

As explained in more detail below in reference to FIG. 2, the metadata displayed to the user via the user interface is frequently retrieved from a header portion of the media file 106. However, there are a variety of sources from which metadata for media files can be retrieved. For example, the playlist can specify metadata that is displayed when playing a media file 106. Generally, metadata specified in the playlist overrides metadata specified in the media file itself. In other words, when playing a media file from a playlist, metadata specified in the playlist is displayed via the user interface instead of corresponding metadata included in the header portion of the media file.

The resultant system 100 allows improved management of metadata to enhance user experience when retrieving metadata of a media file 106. More specifically, the present invention aggregates and resolves properties from potential metadata sources, prioritizes metadata retrieval by metadata source and/or by property, and enables performance improvements by retrieving metadata from sources that are less time consuming.

Referring next to FIG. 2, the components of an exemplary media file 202 (e.g., media file 106) are shown. In this case, the media file 202 represents a song track such as described above in reference to FIG. 1. The media file 202 includes a body section 204 and a header section 206. The body 204 stores digital audio information that is used by the media player application 104 to play the particular music track. Although the body 204 is described herein as storing digital audio information, it is contemplated that the body 204 of a media file 202 may include digital video information. The header 206 stores digital information, which is used by the media player application 104 to display information (i.e., metadata) about the particular music track. For example, the header 206 may include track information such as the song title, song artist, and album title for the work as stored metadata. The header 206 includes a plurality of metadata fields 208 that each store property data for a particular category of metadata. Property data defines one or more properties that the media file 202 has within the particular metadata category. For instance, metadata field #1 may store information related to a genre category, and may have a property that indicates the genre is “Rock,” or may have property that indicates the genre is both “Rock” and “Ballad.” This information can be displayed via the user interface during playback of the media file.

Although the media file may or may not include metadata in the header section 206, metadata can also be retrieved from client-side playlist files such as ASX, WPL, and M3U files, or server-side playlist files such WSX files. As described above, metadata specified in the playlist will generally override metadata specified in the media file. As a result, properties displayed during playback of the media file may be determined by the source of the media file 202, and not the media file. For example, the playlist may define properties to display when playing a particular media file 202 from the playlist. A playlist is typically a text file that includes a type of markup language, such as an Extensible Markup Language (XML), that can read and understood by the media player.

The following example illustrates elements of an exemplary client-side playlist that specifies a media file to play and properties to display via the user interface when playing a media file from the playlist.

```
<ASX version = “3.0”>
<TITLE>Personalized File Title</TITLE>
<ENTRY>
        <TITLE> An Entry in a Personalized Title</TITLE>
        <AUTHOR>Artist Name</AUTHOR>
        <COPYRIGHT>(c) 2000 Microsoft Corporation</COPYRIGHT
        <REF HREF = “mms://proseware.com/path/Yourfile
</ENTRY>
    </ASX>
```

The ASX element identifies to media player that this is a Windows® Media metafile playlist. The TITLE element identifies the title of the playlist as a whole. In the case of Windows® Media Player, this Title metadata is displayed as a show title. The ENTRY element specifies a particular media file 202 or track in a playlist, and can specify metadata for that particular media file. The title entry within the entry element defines title of the media file 202, the author entry defines the artist (i.e., author) of the media file 202, and the copyright entry identifies any copyright associated with the media file 202. The REF.HREF is the pointer to the location of the media file. The REF element identifies the line as a pointer to media content, while the HREF attribute identifies the URL (i.e., location) of the media file. Although the media file is located on a remote server in the above example, it is to be understood that the playlist may point to one or more media files located on the other computer readable mediums such as the local hard drive of the client computer.

There are also server-side playlists. A server-side playlist is an ordered list of media files that are managed on a server. Similar to the client side playlist, the server side playlist can define properties, which are displayed when playing a media file from the server-side playlist. As known to those skilled in the art, a client side playlist can reference a server side playlist.

As can be seen from the description above, metadata can be retrieved from the media file 202 or a source of the media file 202. In the past, media player applications have taken a ‘last writer wins’ approach to metadata, where the last version of a given attribute that was written would ‘win’ and always be returned when playing the media file. However, this approach fails to recognize that metadata sources can come and go, and fails to link the metadata of the media file to the source of the media file 202. Moreover, this approach does not allow enforcement of proper business rules.

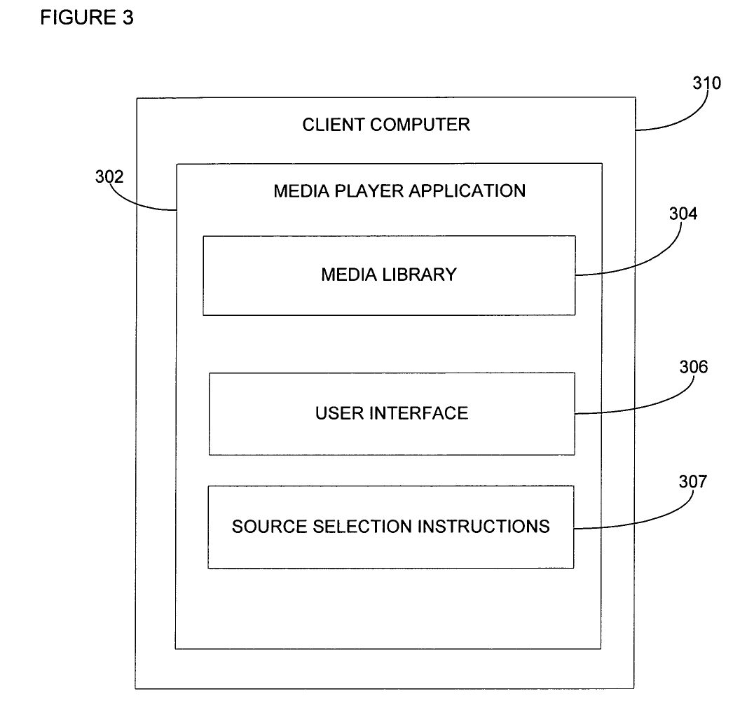

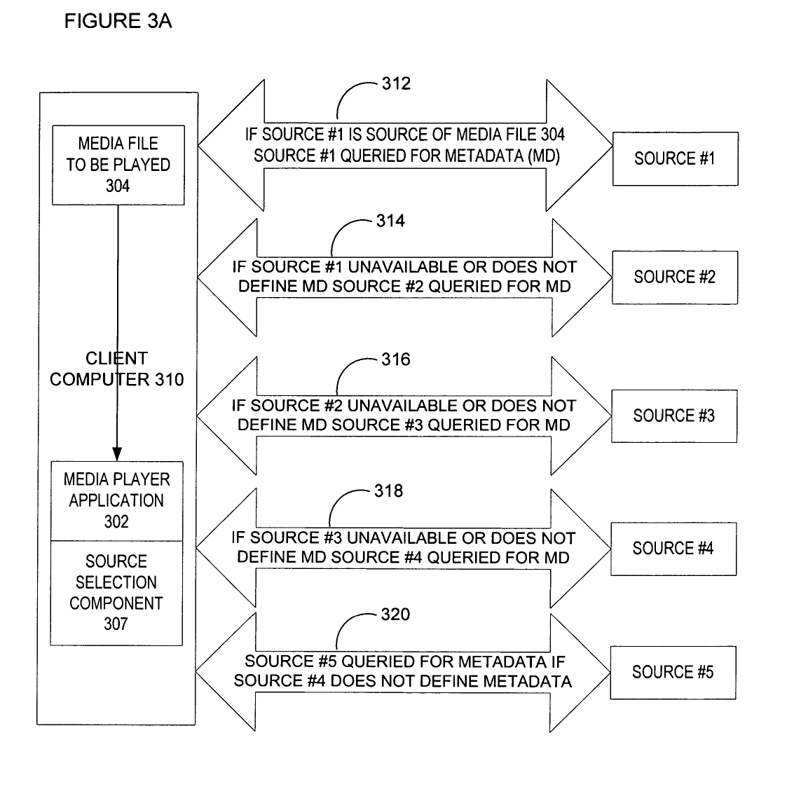

Referring next to FIG. 3, an exemplary block diagram illustrates basic components of a media player application 302 (e.g., media player application 104) having computer executable instructions for storing, and displaying media files 304 (e.g., media files 202) according to one embodiment of the invention. The media player application 302 includes a media library 305 (e.g., memory 110) for storing media files 304, a user interface (UI) 306 for displaying and allowing a user to interact with media files 305, and a source selection component (SSC) 307 for selecting a metadata source from which to retrieve metadata for media files. In this embodiment, a client computer 310 (e.g., computer 102) stores and executes the media player application 302. Upon execution, the media player application 302 identifies all media files 304 on the computer 310 it can process, and transfers the identified files to the media library 305. The UI 306 displays the data in the media library 305, and allows the user to view and/or edit the stored data. The SSC 307 includes computer executable instructions for identifying one or more metadata sources from which to retrieve metadata associated with a particular media file 304.

Prioritization of Metadata by Source

In one embodiment, the media player application 302 executes the SSC 307 to query a plurality metadata sources in order of importance. For purposes of illustration, consider metadata sources arranged in order of importance as shown in FIG. 3A. In this case, Source #1 is pre-defined as the most important and is queried first, and Source #5 is pre-defined as the least important and is queried last. After a user initiates playback of a particular media file 304, the SSC 307 identifies the source of the media file 304 and issues a chain of calls to each source in the plurality metadata sources starting from the source deemed “most important” (e.g., Source #1) to the source deemed “least important” (e.g., Source #5) to identify metadata for the media file 304. The first source to report that it has metadata available ‘wins’, and metadata is returned from that source. If a subsequent source also has the same metadata available, it will not be used. In this example, the identified source of the media file 304 corresponds to Source #1, and SSC 307 queries Source #1, as indicated by 312, to see if it defines metadata for the particular media file 304. If the location of media file 304 identified by Source #1 is not available, SSC 307 queries the next most import source (e.g., Source #2), as indicated by 314. For example, if the media file 304 specified by the playlist is located on a remote server that is currently unavailable, SSC 307 will query the next most import source. Moreover, if Source #1 does not specify metadata for the particular media file 304, the SSC 307 queries the next most import source (e.g., Source #2), as indicated by 314. If the location of media file 304 identified by Source #2 is not available, or if Source #2 does not define metadata for the media file 304, SSC 307 queries the next most import source (e.g., Source #3), as indicated by 316. If Source #3 is unavailable or does not define metadata for the particular media file 304, the SSC 307 queries the source defined as the next most important (e.g., Source #4), as indicated by 318. If Source #4 is unavailable or does not define metadata for the particular media file 304, the SSC 307 queries the source defined as the least important (e.g., Source #5), as indicated by 320. Essentially, the SSC 307 checks each of the sources for availability, compatibility, and metadata according to the predetermined order of importance to retrieve and display metadata for the media file. In one embodiment, the source designated as the least important (e.g., Source #5) corresponds to basic metadata or default metadata. Basic metadata will be retrieved if no other source contains metadata. For example, if no source contains title metadata, basic metadata may be a null value (i.e., nothing displayed), or can be a default such as “Title.”

Notably, if the SSC 307 identifies Source #2 as the source of the media file 304, rather than Source #1, SSC 307 checks each of the sources for availability, compatibility, and metadata beginning with Source #2. If Source #2 is unavailable or does not define metadata for the media file 304, SSC 307 then checks each of the remaining sources (e.g., Source #3-Source #5) according to the predetermined order of importance to retrieve and display metadata for the media file 304.

Referring now to Table 1, six (6) metadata sources that can provide properties for a media file 304 are arranged in order of importance, and properties defined by each source are shown. Although the invention can be used for selecting a source of metadata from a plurality of metadata sources, for purposes of illustration the invention is described below in connection with the six (6) metadata sources.

| QUERY | METADATA | COPYRIGTHT | AUTHOR | TITLE |
|---|---|---|---|---|
| ORDER | SOURCE | Property | Property | Property |
| 1 | ASX Source | “Song, Inc” | None | “Favorite |
| | | | | Duet” |
| 2 | WSX Source | None | Sinatra | “Great |
| | | | | Duets” |
| 3 | Media Library | None | None | None” |
| 4 | File Header | None | Frank | “Duets” |
| | | | Sinatra | |
| 5 | DRM Header | “Records, Inc.” | NA | NA |
| 6 | Basic Metadata | NA | Artist | Title |

An ASX source defines properties specified in a client side playlist such as an ASX file. Properties defined in the ASX source will generally override those properties found in the header of the media file 304. A WSX source defines properties specified in a server-side playlist file such as a WSX file. Properties defined in a WSX source can be overridden by properties in the ASX Source, but they also can override properties found in the media file 304. A media library source defines properties specified in the media player's media library. Although, such properties typically mirror the properties in the media file 304, they can be different if the media file 304 is not in sync with the library (due to a latent write or a read-only/permissions issue). As an example, the user interface may allow users change metadata associated with any media file in media library. Thereafter, the library latently writes the change back to the file to put the file in sync with the media library. However, in some instances the file may not always be available for writing. For example, a file that been marked read only. In this case, the metadata in the library may not match the metadata of the media file. In addition, there are some properties that are not stored within a media file. For example, one such property is the number of times a particular media file has been played. File header source refers to properties specified in the media file's header. DRM header source refers to properties specified in the media file's DRM header if the media file has DRM protection. DRM stands for Digital Rights Management, and is used to describe various technologies, which can be used to protect digital content from unauthorized copying. If the DRM header is signed, then certain header attributes should always win over all other possible sources of metadata. Basic metadata refers to properties that do not resolve to a specific source are read from and written to this metadata source.

As described above, when a user initiates playback of a media file 304, the SSC 307 identifies the source of the media file 304. For instance, the SSC 307 may identify the source of a media file 304 from a file extension associated with a client side playlist, such as a playlist file having an .asx file extension. In this case, the SSC 307 identifies the source of the media file 304 as an ASX file (i.e., ASX Source), and checks the ASX file for defined properties such as duration, title, copyright, and/or artist. As another example, the SSC 307 may identify the source of a media file 304 from the file extension associated with a server side playlist, such as a metafile having a .wsx file extension. In this case, the SSC 307 identifies the source of the media file 304 as a WSX file (i.e., WSX Source), and checks the WSX Source for defined properties such as copyright, title, and/or artist.

Referring again to Table 1, if the SSC 307 identifies the source of the media file 304 as an ASX source, the ASX source is queried and copyright property, “Song, Inc.,” and the title property, “Favorite Duet” defined in the ASX source is retrieved and displayed via the user interface. Although other sources in Table 1 define a copyright property and a title property, because the ASX source is deemed the most import and is queried first, the properties specified in ASX Source are retrieved. As another example, consider a media file 304 included in a server side playlist (e.g., WSX source), and that the server side playlist is specified (i.e., pointed to) in a client side playlist (e.g., ASX source). In this case, the SSC 307 again will identify the source of the media file 304 as an ASX source. However, because an author property is not specified in the ASX source, the WSX source is queried and the author property defined in the WSX source, “Sinatra” is retrieved and displayed via the user interface. Although the file header specifies a title author property, because the WSX source is deemed more important, the author property specified in the WSX Source is retrieved.

Distinguishing metadata by source allows metadata sources to come and go. For example, if the user begins playback of a media file 304 from the media library, the library source is implicitly present. If during the playback, the item is deleted from the library (but not the disk), then the library metadata source can be removed from the media. This potentially removes some available metadata, but due to the availability of metadata from the other metadata sources, the library source can be seamlessly removed. Similarly, the item can then be re-added to the Media Library, and a metadata source can seamlessly be added to the item in its proper prioritization. Moreover, because obtaining metadata from some of the sources listed above can be a time consuming process that requires reading and parsing the media file header from disk, querying the library, or issuing download requests, the predefined order can incorporate source optimization to avoid more expensive (time consuming) sources. For example, consider a playlist that is loaded from an ASX file (i.e., client side playlist). The title property is likely available in the file's header metadata, and potentially available from the media library as well. However, by querying the ASX file (i.e., ASC source) first, which specifies the title, “Favorite Duet”, the more expensive sources can be avoided. As a result, metadata retrieval time is reduced, and the over all experience of the user is enhanced.

Furthermore, by checking sources according to a predetermined order of importance, the invention persistently and consistently retrieves metadata from a preferred source. For example, if the media is read from an ASX file, which specifies the title property, the user cannot overwrite the attribute specified by the ASX file. As another example, if the metadata of media file is changed in a media library, the media library source will persist, if preferred over the media file (See Table 1), and metadata will be retrieved from the media library source.

Property Based Source Selection

In another embodiment, the SSC 307 includes instructions for overriding the source-based prioritization in order to comply with business rules for certain media content. More specifically, the instructions can indicate per-property the search order of the metadata sources and/or a potential inclusion/exclusion list of sources to search. For example, when retrieving a copyright property the source-based prioritization is the proper way to resolve the metadata source from which the property is retrieved. However, when the DRM header is signed, then business rules dictate that the DRM header's attribution/copyright property should always win over any other possible source from which the attribute may be retrieved. If the attribute is not present in the DRM header, the normal source resolution can occur to locate the attribute. Referring again to Table 1, because the DRM header is signed, SSC 307 will ignore the copyright property specified in any other source and retrieve the attribution/copyright specified by the DRM header. In other words, if the DRM header is signed, the copyright property cannot be modified, and will be returned as defined in the DRM header.

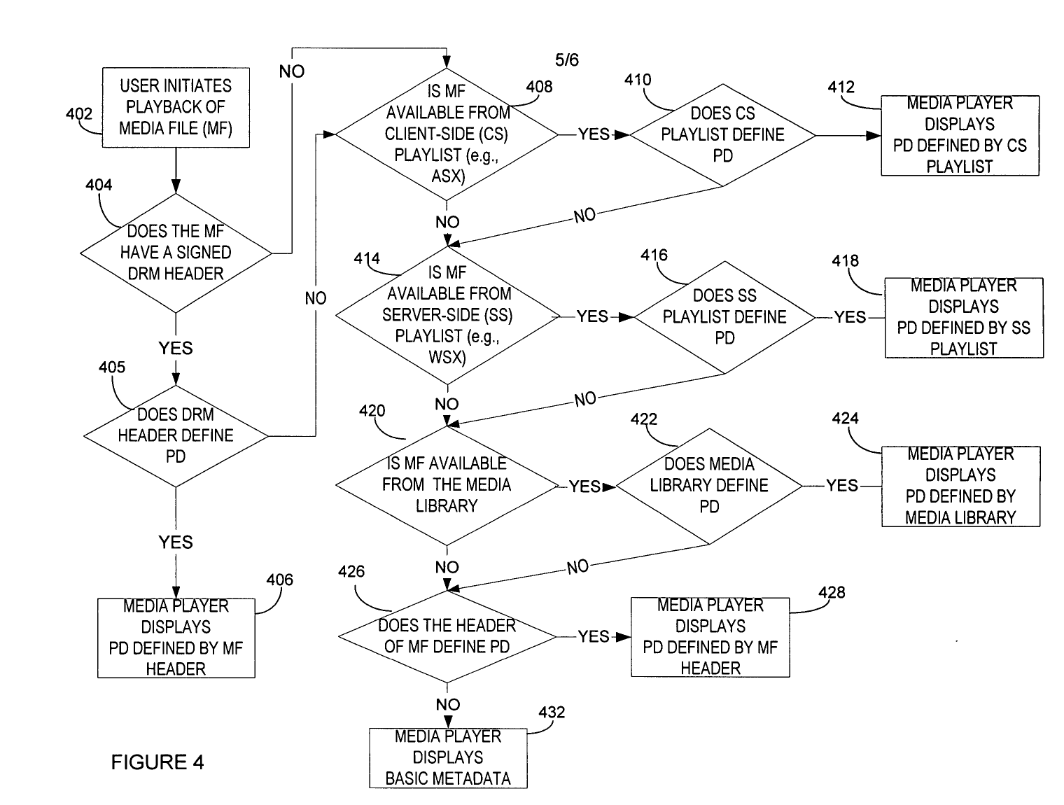

Referring next to FIG. 4, an exemplary flow chart illustrates a method of retrieving metadata of a media file according to one embodiment of the invention. At 402 the user initiates playback of the media file. If the media file has DRM protection, the media player application (MPA) pareses the DRM header of the media file to determine if it is signed at 404. If the MPA determines that the DRM header is signed, the MPA determines if the DRM header specifies property data for the media file at 405. If DRM specifies property data for the media file, the MPA retrieves the property data specified in the media file's DRM header at 406. If the DRM header is not signed, or the DRM does not specify property data for the media file, the MPA determines if the source of the media file is a client side playlist file (CS playlist) such as ASX file at 408. If the source of the media file is a CS playlist, the MPA determines if the CS playlist specifies property data for the media file at 410. If the CS playlist specifies property data for the media file, the property data specified in the CS playlist is displayed via a graphical user interface at 412. Alternatively, if the MPA determines that the source of the media file is not a CS playlist at 408, or if the MPA determines that the CS playlist does not specify property data for the media file at 410, the MPA determines if the source of the media file is a server-side playlist file (SS playlist) such as WSX file at 414. If the source of the media file is a SS playlist, the MPA determines if the SS playlist specifies property data for the media file at 416. If the SS playlist specifies property data for the media file, the property data specified in the CS playlist is displayed via the graphical user interface at 418. Alternatively, if the MPA determines that the source of the media file is not a SS playlist at 414, or if the MPA determines that the SS playlist does not specify property data for the media file at 416, the MPA determines if the source of the media file is the media library at 420. If the source of the media file is the media library at 420, the MPA determines if the media library specifies property data for the media file at 422. If the media library specifies property data for the media file, the property data specified in the media library is displayed via the graphical user interface at 424. Alternatively, if the MPA determines that the source of the media file is not the media library at 420, or if the MPA determines that the media library does not specify property data for the media file at 422, the MPA determines if header of the media file defines property data for the media file at 426. If the header of the media file defines property data for the media file, the property data specified in the header of the media file is displayed via the graphical user interface at 428. If the header of the media file does not define property data for the media file, the MPA retrieves basic metadata for the media file at 430.

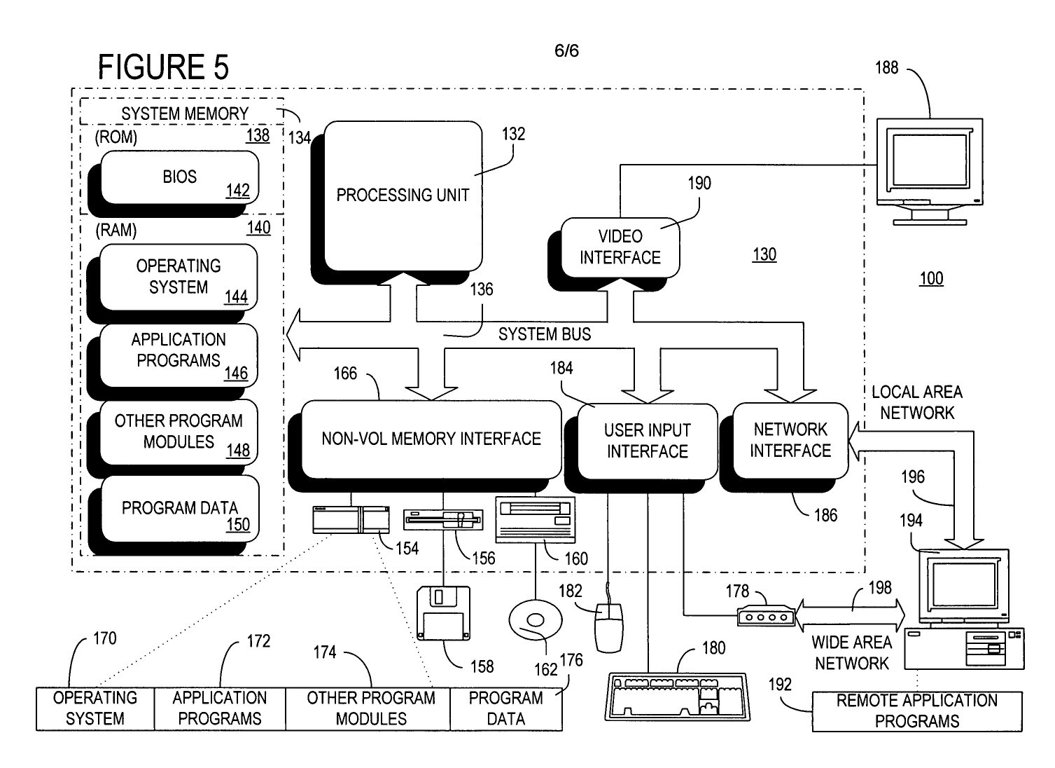

FIG. 5 shows one example of a general purpose computing device in the form of a computer 130. In one embodiment of the invention, a computer such as the computer 130 is suitable for use in the other figures illustrated and described herein. Computer 130 has one or more processors or processing units 132 and a system memory 134. In the illustrated embodiment, a system bus 136 couples various system components including the system memory 134 to the processors 132. The bus 136 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 130 typically has at least some form of computer readable media. Computer readable media, which include both volatile and nonvolatile media, removable and non-removable media, may be any available medium that can be accessed by computer 130. By way of example and not limitation, computer readable media comprise computer storage media and communication media. Computer storage media include volatile and nonvolatile, removable and non-removable media implemented in any method or technology for storage of information such as computer readable instructions, data structures, program modules or other data. For example, computer storage media include RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computer 130. Communication media typically embody computer readable instructions, data structures, program modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Wired media, such as a wired network or direct-wired connection, and wireless media, such as acoustic, RF, infrared, and other wireless media, are examples of communication media. Combinations of the any of the above are also included within the scope of computer readable media.

The system memory 134 includes computer storage media in the form of removable and/or non-removable, volatile and/or nonvolatile memory. In the illustrated embodiment, system memory 134 includes read only memory (ROM) 138 and random access memory (RAM) 140. A basic input/output system 142 (BIOS), containing the basic routines that help to transfer information between elements within computer 130, such as during start-up, is typically stored in ROM 138. RAM 140 typically contains data and/or program modules that are immediately accessible to and/or presently being operated on by processing unit 132. By way of example, and not limitation, FIG. 5 illustrates operating system 144, application programs 146, other program modules 148, and program data 150.

The computer 130 may also include other removable/non-removable, volatile/nonvolatile computer storage media. For example, FIG. 5 illustrates a hard disk drive 154 that reads from or writes to non-removable, nonvolatile magnetic media. FIG. 5 also shows a magnetic disk drive 156 that reads from or writes to a removable, nonvolatile magnetic disk 158, and an optical disk drive 160 that reads from or writes to a removable, nonvolatile optical disk 162 such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 154, and magnetic disk drive 156 and optical disk drive 160 are typically connected to the system bus 136 by a non-volatile memory interface, such as interface 166.

The drives or other mass storage devices and their associated computer storage media discussed above and illustrated in FIG. 5, provide storage of computer readable instructions, data structures, program modules and other data for the computer 130. In FIG. 5, for example, hard disk drive 154 is illustrated as storing operating system 170, application programs 172, other program modules 174, and program data 176. Note that these components can either be the same as or different from operating system 144, application programs 146, other program modules 148, and program data 150. Operating system 170, application programs 172, other program modules 174, and program data 176 are given different numbers here to illustrate that, at a minimum, they are different copies.

A user may enter commands and information into computer 130 through input devices or user interface selection devices such as a keyboard 180 and a pointing device 182 (e.g., a mouse, trackball, pen, or touch pad). Other input devices (not shown) may include a microphone, joystick, game pad, satellite dish, scanner, or the like. These and other input devices are connected to processing unit 132 through a user input interface 184 that is coupled to system bus 136, but may be connected by other interface and bus structures, such as a parallel port, game port, or a Universal Serial Bus (USB). A monitor 188 or other type of display device is also connected to system bus 136 via an interface, such as a video interface 190. In addition to the monitor 188, computers often include other peripheral output devices (not shown) such as a printer and speakers, which may be connected through an output peripheral interface (not shown).

The computer 130 may operate in a networked environment using logical connections to one or more remote computers, such as a remote computer 194. The remote computer 194 may be a personal computer, a server, a router, a network PC, a peer device or other common network node, and typically includes many or all of the elements described above relative to computer 130. The logical connections depicted in FIG. 5 include a local area network (LAN) 196 and a wide area network (WAN) 198, but may also include other networks. LAN 136 and/or WAN 138 can be a wired network, a wireless network, a combination thereof, and so on. Such networking environments are commonplace in offices, enterprise-wide computer networks, intranets, and global computer networks (e.g., the Internet).

When used in a local area networking environment, computer 130 is connected to the LAN 196 through a network interface or adapter 186. When used in a wide area networking environment, computer 130 typically includes a modem 178 or other means for establishing communications over the WAN 198, such as the Internet. The modem 178, which may be internal or external, is connected to system bus 136 via the user input interface 184, or other appropriate mechanism. In a networked environment, program modules depicted relative to computer 130, or portions thereof, may be stored in a remote memory storage device (not shown). By way of example, and not limitation, FIG. 5 illustrates remote application programs 192 as residing on the memory device. It will be appreciated that the network connections shown are exemplary and other means of establishing a communications link between the computers may be used.

Generally, the data processors of computer 130 are programmed by means of instructions stored at different times in the various computer-readable storage media of the computer. Programs and operating systems are typically distributed, for example, on floppy disks or CD-ROMs. From there, they are installed or loaded into the secondary memory of a computer. At execution, they are loaded at least partially into the computer's primary electronic memory. The invention described herein includes these and other various types of computer-readable storage media when such media contain instructions or programs for implementing the steps described below in conjunction with a microprocessor or other data processor. The invention also includes the computer itself when programmed according to the methods and techniques described herein.

For purposes of illustration, programs and other executable program components, such as the operating system, are illustrated herein as discrete blocks. It is recognized, however, that such programs and components reside at various times in different storage components of the computer, and are executed by the data processor(s) of the computer.

Although described in connection with an exemplary computing system environment, including computer 130, the invention is operational with numerous other general purpose or special purpose computing system environments or configurations. The computing system environment is not intended to suggest any limitation as to the scope of use or functionality of the invention. Moreover, the computing system environment should not be interpreted as having any dependency or requirement relating to any one or combination of components illustrated in the exemplary operating environment. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

The invention may be described in the general context of computer-executable instructions, such as program modules, executed by one or more computers or other devices. Generally, program modules include, but are not limited to, routines, programs, objects, components, and data structures that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

In operation, computer 130 executes computer-executable instructions such as those illustrated in FIG. 4 to display one or more properties of a media file being played via a media player

When introducing elements of the present invention or the embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

In view of the above, it will be seen that the several objects of the invention are achieved and other advantageous results attained.

As various changes could be made in the above constructions and methods without departing from the scope of the invention, it is intended that all matter contained in the above description and shown in the accompanying drawings shall be interpreted as illustrative and not in a limiting sense.

1. A method for retrieving a property of a media file being played via a media player, wherein the media file is retrieved from one of a plurality of media file sources, which are prioritized, comprising:
identifying a source of the media file; and
displaying the property as defined by metadata of the identified source of the media file.

2. The method of claim 1, wherein retrieving includes retrieving the property defined by the source having the highest priority below the identified source of the media file when the identified source does not define the property.

3. The method of claim 1 further including:
querying each of the media file sources according to their priority to identify a property for the media file defined by the metadata of the source of the media file; and
retrieving the property as defined by the metadata of a first source in the priority identified as including metadata defining the property.

4. The method of claim 3, wherein each media file source corresponds to a metadata source, and wherein querying includes querying each of the metadata sources to identify the property for the media file.

5. The method of claim 4, wherein the priority for querying each of the metadata sources is determined according to a predetermined importance assigned to each of the plurality of metadata sources, wherein the metadata source deemed most important is queried first, and wherein the metadata source deemed least important is queried last.

6. The method of claim 5, wherein querying includes issuing a chain of calls to each metadata source, wherein a first call is to the metadata source deemed most important, and wherein a subsequent call is to the metadata source deemed the next most important, and wherein a last call is to the metadata source deemed the least important.

7. The method of claim 6, wherein the property to be displayed determines the metadata source from which to retrieve the property

8. The method of claim 1, wherein retrieving includes retrieving metadata from the metadata source that returns the property in the least amount of time.

9. The method of claim 1, wherein the plurality of metadata sources include:
an ASX source;
an WSX source;
a media library source;
a file header source;
a DRM source, and
a basic metadata source.

10. A computer readable medium having computer executable instructions for retrieving a property of a media file being played via a media player, wherein the media file is retrieved from one of a plurality of media file sources, which are prioritized, comprising:
identifying instructions for identifying a source of the media file; and
retrieving instructions for retrieving the property as defined by metadata of the identified source of the media file.

11. The computer readable medium of claim 10, wherein retrieving instructions include retrieving the property defined by the source having the highest priority below the identified source of the media file when the identified source does not define the property.

12. The computer readable medium of claim 10 further including querying instructions for querying each of the media file sources according to their priority to identify a property for the media file defined by the metadata of the source of the media file, and wherein retrieving instructions retrieve the property as defined by the metadata of a first source in the priority identified as including metadata defining the property.

13. The computer readable medium of claim 12, wherein each media file source corresponds to a metadata source, and wherein querying includes querying each of the metadata sources to identify the property for the media file.

14. The computer readable medium of claim 13, wherein the priority for querying each of the metadata sources is determined according to a predetermined importance assigned to each of the plurality of metadata sources, wherein the metadata source deemed most important is queried first, and wherein the metadata source deemed least important is queried last.

15. The computer readable medium of claim 14, wherein querying instructions issue a chain of calls to each metadata source, wherein a first call is to the metadata source deemed most important, and wherein a subsequent call is to the metadata source deemed the next most important, and wherein a last call is to the metadata source deemed the least important.

16. The computer readable medium of claim 10, wherein retrieving instructions determine the metadata source from which to retrieve the property as a function of the property to be displayed

17. The computer-readable medium of claim 10, wherein retrieving instructions retrieve metadata from the metadata source that returns the property in the least amount of time.

18. The method of claim 10, wherein the plurality of metadata sources include:
an ASX source;
an WSX source;
a media library source;
a file header source;
a DRM source, and
a basic metadata source.

19. A computer readable medium having stored thereon a data structure, comprising:
a first data field comprising data representing a plurality of metadata sources, wherein each metadata source specifies metadata to display while playing a media file via a media application;
a second data field containing data representative of the media file; and
a third functioning field identifying one of the plurality of metadata sources as a function of the data contained in the second data field, and wherein metadata included in the identified metadata source is retrieved while playing the media file via the media application.

20. The computer-readable medium of claim 19, wherein each metadata source corresponds to a source of the media file.

21. The computer-readable medium of claim 19, wherein the third functioning field queries each of the plurality of metadata sources as a function of a preference assigned to each metadata source to identify the metadata source from which to retrieve metadata, and wherein the priority for querying each of the metadata sources is determined according to a predetermined importance assigned to each of the plurality of metadata sources, wherein the metadata source deemed most important is queried first, and wherein the metadata source deemed least important is queried last.

22. The computer-readable medium of claim 19, wherein the third functioning field identifies the metadata source from which to retrieve metadata as a function of the amount of time it takes the metadata source to return metadata, wherein the metadata source that returns metadata in the least amount of time is identified.
